(19) United States
(12) Patent Application Publication
(10) Pub. No.: US 2019/0075578 A1
(43) Pub. Date: Mar. 7, 2019

(54) RADIO ACCESS NETWORK SLICING CONTROL DEVICE AND METHOD BY WHICH DEVICE CONTROLS RADIO BEARER TRANSMISSION

(71) Applicant: KT CORPORATION, Gyeonggi-do (KR)

(72) Inventor: Ha Sung KIM, Seoul (KR)

(73) Assignee: KT CORPORATION, Gyeonggi-do (KR)

(21) Appl. No.: 16/084,221

(22) PCT Filed: Mar. 9, 2017
(86) PCT No.: PCT/KR2017/002558

§ 371 Date: Sep. 11, 2018

(30) Foreign Application Priority Data
Mar. 11, 2016 (KR) 10-2016-0029431
Mar. 8, 2017 (KR) 10-2017-0029374

(51) Int. Cl. H04W 72/12; H04W 28/02; H04W 48/18; H04B 17/364; H04W 48/10; H04W 16/12

(52) U.S. Cl. CPC H04W 72/1236; H04W 28/0236; H04W 16/12; H04B 17/364; H04W 48/10; H04W 48/18

(57) ABSTRACT

Provides are a method and device for performing radio bearer transmission when different base stations cooperate in a 5G radio access network (RAN) that employs network slicing. The method of a device for controlling a bearer split transmission may include receiving slice ID from a core network, mapping the slice ID to a radio bearer, and controlling a radio bearer transmission by using the slice ID and data-related information of a master base station or a secondary base station.

### TECHNICAL FIELD

Embodiments relate to a method and device for transmitting radio bearer when different base stations cooperate with each other in a 5G Radio Access Network (RAN) employing network slicing.

### BACKGROUND ART

The related technology of the present disclosure is a 5G network, a millimeter wave radio access network, network slicing, and dual connectivity.

Typical LTE networks have the same core and access network configuration and dedicated equipment. In such LTE networks, it is difficult to configure a virtual network in accordance with services and requirements thereof. Further, it is difficult and requires excessive cost to change the configuration of the networks in order to provide end-to-end quality to terminals. Moreover, the LTE networks are simply operated regardless of a service that requires dual connectivity to transmit data between base stations.

Network slicing has been introduced for 5G to provide various services having various requirements and characteristics. Through the network slicing, it may be possible to virtually provide dedicated networks specified for services by logically separating one physical network into virtual networks, such as an end-to-end network, a core network, a transmission network, and a radio access network.

However, base stations employing dual connectivity do not consider such different network slices to perform separate transmission of bearers. Accordingly, it is difficult to satisfy the capacity and the quality of latency required by the slices.

### DETAILED DESCRIPTION OF THE INVENTION

### Technical Problem

An aspect of the present disclosure is to provide a method and device for transmitting a radio bearer when different base stations cooperate with each other in a 5G RAN to which network slicing has been applied.

### Technical Solution

According to an aspect, a method may be provided for controlling radio bearer transmission through a radio access network slicing control device. The method may include: receiving a slice ID from a core network; mapping the received slice ID to a radio bearer; and selecting a base station for transmitting the radio bearer, using the slice ID mapped to the radio bearer and information on a master base station and a secondary base station.

According to another aspect, a radio access network slicing control device may be provided for controlling radio bearer transmission. The device may include: a slice ID mapper configured to receive a slice ID from a core network and map the received slice ID to a radio bearer; a base station information receiver configured to receive information on a master base station and a secondary base station through the master base station; and a radio bearer transmission processor configured to select a base station for transmitting the radio bearer, using the slice ID mapped to the radio bearer and the information about the data of the master base station and the secondary base station.

### Advantageous Effects

According to embodiments, high-speed and low-latency wireless transmission of various 5G services may be stably performed by interoperated and separated transmission between base stations on a radio access network. Further, it is also possible to reduce the costs for construction/operation through efficient interoperations of a plurality of base stations.

### BRIEF DESCRIPTION OF THE DRAWINGS

FIG. 1 is a diagram for describing the concept of 5G network slicing;

FIG. 2 is a diagram illustrating a base station interoperation structure based on dual connectivity;

FIG. 3 is a diagram showing a packet flow control configuration between base stations;

FIG. 4 is a diagram showing a radio access network slicing control system according to embodiments;

FIGS. 5 to 7 are flowcharts for describing a method of controlling radio bearer transmission through the radio access network slicing control system according to embodiments;

FIG. 8 is a diagram showing a base station according to embodiments; and

FIG. 9 is a diagram showing of a user terminal according to embodiments.

### MODE FOR CARRYING OUT THE INVENTION

Hereinafter, embodiments of the present disclosure will be described in detail with reference to the accompanying drawings. In adding reference numerals to elements in each drawing, the same elements will be designated by the same reference numerals, if possible, although they are shown in different drawings. Further, in the following description of the present disclosure, a detailed description of known functions and configurations incorporated herein will be omitted when it is determined that the description may make the subject matter of the present disclosure rather unclear.

In the present specifications, a machine type communication (MTC) terminal refers to a terminal that is low cost (or is not very complexity), a terminal that supports coverage enhancement, or the like. In the present specifications, the MTC terminal refers to a terminal that supports low cost (or low complexity) and coverage enhancement. Alternatively, in the present specifications, the MTC terminal refers to a terminal that is defined as a predetermined category for maintaining low costs (or low complexity) and/or coverage enhancement.

In other words, in the present specifications, the MTC terminal may refer to a newly defined 3GPP Release 13 low cost (or low complexity) UE category/type, which executes LTE-based MTC related operations. Alternatively, in the present specifications, the MTC terminal may refer to a UE category/type that is defined in or before 3GPP Release-12 that supports the enhanced coverage in comparison with the existing LTE coverage, or supports low power consumption, or may refer to a newly defined Release 13 low cost (or low complexity) UE category/type.

The wireless communication system may be widely installed to provide various communication services, such as a voice service, a packet data service, and the like. The wireless communication system may include a User Equipment (UE) and a Base Station (BS or an eNB). Throughout the specifications, the user equipment may be an inclusive concept indicating a user terminal utilized in wireless communication, including a UE (User Equipment) in wideband code division multiple access (WCDMA), long term evolution (LTE), high speed packet access (HSPA), and the like, and an MS (Mobile station), a UT (User Terminal), an SS (Subscriber Station), a wireless device, and the like in global systems for mobile communication (GSM).

A base station or a cell may generally refer to a station that performs communication with a User Equipment (UE) and may also be referred to as a Node-B, an evolved Node-B (eNB), a Sector, a Site, a Base Transceiver System (BTS), an Access Point, a Relay Node, a Remote Radio Head (RRH), a Radio Unit (RU), and the like.

That is, the base station or the cell may be construed as an inclusive concept indicating a portion of an area covered by a BSC (Base Station Controller) in CDMA, a NodeB in WCDMA, an eNB or a sector (site) in LTE, and the like, and the concept may include various coverage areas, such as a megacell, a macrocell, a microcell, a picocell, a femtocell, a communication range of a relay node, and the like.

Each of the above-mentioned various cells has a base station that controls a corresponding cell. Thus, the base station may be construed in two ways. i) the base station may be a device that provides a megacell, a macrocell, a microcell, a picocell, a femtocell, and a small cell in association with a wireless area, or ii) the base station may indicate a wireless area itself. In i), a base station may be all devices that interact with one another and controlled by an identical entity to provide a predetermined wireless area or all devices that cooperate with each other to configure the predetermined wireless area. Based on a configuration type of a wireless area, an eNB, an RRH, an antenna, an RU, a Low Power Node (LPN), a point, a transmission/reception point, a transmission point, a reception point, and the like may be embodiments of a base station. In ii), a base station may be a wireless area itself that receives or transmits a signal from a perspective of a terminal or a neighboring base station

Therefore, a megacell, a macrocell, a microcell, a picocell, a femtocell, a small cell, an RRH, an antenna, an RU, an LPN, a point, an eNB, a transmission/reception point, a transmission point, and a reception point are commonly referred to as a base station.

In the specifications, the user equipment and the base station are used as two inclusive transceiving subjects to embody the technology and technical concepts described in the specifications. However, embodiments are not be limited to a predetermined term or word. In the specification, the user equipment and the base station are used as two (uplink or downlink) inclusive transceiving subjects to embody the technology and technical concepts described in the specifications and may not be limited to a predetermined term or word. Here, Uplink (UL) refers to data transmission and reception from a UE to a base station, and Downlink (DL) refers data transmission and reception from a base station to a UE.

Varied multiple access schemes may be unrestrictedly applied to the wireless communication system. Various multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, OFDM-CDMA, and the like may be used. An embodiment of the present disclosure may be applicable to resource allocation in an asynchronous wireless communication scheme that is advanced through GSM, WCDMA, and HSPA, to be LTE and LTE-advanced, and may be applicable to resource allocation in a synchronous wireless communication scheme that is advanced through CDMA and CDMA-2000, to be UMB. The present disclosure may not be limited to a specific wireless communication field, and may include all technical fields in which the technical idea of the present disclosure is applicable.

Uplink transmission and downlink transmission may be performed i) based on a TDD (Time Division Duplex) scheme that performs transmission based on different times or ii) based on an FDD (Frequency Division Duplex) scheme that performs transmission based on different frequencies.

Further, a standard for a system such as LTE and LTE-A may be developed by configuring an uplink and a downlink based on a single carrier or a pair of carriers. The uplink and the downlink may transmit control information through a control channel, such as a PDCCH (Physical Downlink Control CHannel), a PCFICH (Physical Control Format Indicator CHannel), a PHICH (Physical Hybrid ARQ Indicator CHannel), a PUCCH (Physical Uplink Control CHannel), an EPDCCH (Enhanced Physical Downlink Control CHannel), and the like. The uplink and downlink may transmit data information through a data channel, such as a PDSCH (Physical Downlink Shared CHannel), a PUSCH (Physical Uplink Shared CHannel), and the like.

Control information may be transmitted using an EPDCCH (enhanced PDCCH or extended PDCCH).

In the present specification, a cell may refer to the coverage of a signal transmitted from a transmission/reception point, a component carrier having the coverage of the signal transmitted from the transmission/reception point (transmission point or transmission/reception point), or the transmission/reception point itself.

A wireless communication system, according to embodiments, refers to a Coordinated Multi-point transmission/reception (CoMP) system where two or more transmission/reception points cooperatively transmit a signal, a coordinated multi-antenna transmission system, or a coordinated multi-cell communication system. A CoMP system may include at least two multi-transmission/reception points and terminals.

A multi-transmission/reception point may be i) a base station or ii) a macro cell (hereinafter, referred to as an ‘eNB’) and at least one RRH that is connected to the eNB and controlled by the eNB through an optical cable or an optical fiber. Further, the at least one RRH has a high transmission power or a low transmission power within a macro cell area.

Hereinafter, a downlink refers to communication or a communication path from a multi-transmission/reception point to a terminal, and an uplink refers to communication or a communication path from a terminal to a multi-transmission/reception point. In an uplink, a transmitter may be a part of a terminal and a receiver may be a part of a multiple transmission/reception point. In an uplink, a transmitter may be a part of a terminal and a receiver may be a part of a multiple transmission/reception point.

Hereinafter, signal transmission and reception through a PUCCH, a PUSCH, a PDCCH, an EPDCCH, or a PDSCH may be described through the expression, “a PUCCH, a PUSCH, a PDCCH, an EPDCCH, or a PDSCH is transmitted or received”.

In addition, hereinafter, the expression “a PDCCH is transmitted or received, or a signal is transmitted or received through a PDCCH” has the same meaning of the expression “an EPDCCH is transmitted or received, or a signal is transmitted or received through an EPDCCH”.

That is, a physical downlink control channel used herein may indicate a PDCCH or an EPDCCH. Further, the physical downlink control channel may indicate a meaning including both a PDCCH and an EPDCCH.

For convenience of description and ease of understanding, a PDCCH is used to describe some embodiments of the present disclosure. However, an EPDCCH may be applied similarly to the same embodiments. Furthermore, an EPDCCH is used to describe some embodiments of the present disclosure. Similarly, the PDCCH may be applied to the same embodiments.

Meanwhile, higher layer signaling includes an RRC signaling that transmits RRC information including an RRC parameter.

An eNB executes downlink transmission to terminals. The eNB may transmit a Physical Downlink Shared Channel (PDSCH) which is a primary physical channel for unicast transmission. The eNB may transmit a Physical Downlink Control Channel (PDCCH) for transmitting downlink control information, such as scheduling required for reception of a PDSCH, and scheduling grant information for transmission of an uplink data channel (for example, a Physical Uplink Shared Channel (PUSCH)). Hereinafter, transmission and reception of a signal through each channel will be described as transmission and reception of a corresponding channel.

The related technology of the present disclosure is 5G network, a millimeter wave-based radio access network, network slicing, and dual connectivity.

Typical LTE networks have the same core and access network configuration and dedicated equipment. It is difficult to configure a virtual network in accordance with services and requirements thereof. Further, it is difficult and takes f excessive cost to change the configuration of the networks in order to provide end-to-end quality to terminals. Moreover, the LTE networks are simply operated regardless of a service requiring dual connectivity to transmit data between base stations.

Network slicing has been introduced for 5G to provide various services having various requirements and characteristics. Through the network slicing, it may be possible to virtually provide dedicated networks specified for services by logically separating one physical network into virtual separate networks, such as an end-to-end network=a core network, a transmission network, and an access network.

However, base stations employing dual connectivity do not consider such different network slices to perform separate transmission of bearers. Accordingly, it is difficult to satisfy the capacity and the quality of latency required by the slices.

In accordance with an aspect of the present disclosure, a method and device may be provided for transmitting a radio bearer when different base stations cooperate with each other in a 5G Radio Access Network (RAN) to which network slicing has been applied.

A radio access system on a 5G network is composed of a Central Unit (CU) and an Access Unit (AU). The CU includes the functions of protocol hierarchies 2 and 3, and the AU includes physical hierarchy, RF, and antenna functions.

Using network slicing, it is possible to quickly configure a network and reduce the costs by configuring several virtual logical networks from one physical network without configuration specific physical networks for various 5G services.

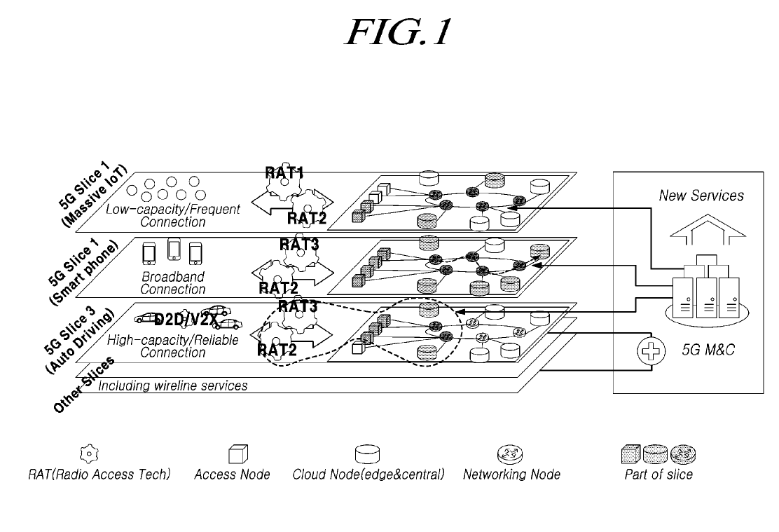

FIG. 1 shows network slicing for providing 5G services.

Three main services of 5G are mobile broadband service (MBB) being capable of transmitting large data at a high speed, Mission-critical MTC having low latency and high reliability, and Massive MTC that is a low-capacity/low-speed IoT service using sensors.

Slices are separately made for different services and may be discriminated by slice identifiers, Slice IDs. Different network functions and performances would be provided for different slices. Accordingly, slices may be discriminated and identified, as in the following Table 1. The slices may be classified in more detail in accordance with the kinds or purposes of services (e.g., a virtual broadcasting slice, a drone slice, a self-driving car slice). This information is stored and shared in a core and an access network.

Table 1 shows an example of classification of representative slice identifiers (Slice ID).

TABLE 1
Example of slice identifiers

| Slice ID (SLID) | Service | Characteristics |
|---|---|---|
| SLID_{MMB} | Mobile broadband | Large capacity, high speed, |
| | | high processing speed |
| SLID_{MAMTC} | Massive MTC | Small capacity, low speed, |
| | | low power, massive |
| | | simultaneous access, low |
| | | mobility |
| SLID_{MCMTC} | Mission-critical MTC | Low latency, high |
| | | reliability |

An inter-base station interface connecting two base stations supports dual connectivity that allows a terminal to be connected to two base stations and to perform wireless transmission, by operating in combination with a standardized X2 protocol. In particular, it is assumed that an S1 interface is connected to an MeNB (Master eNB), thereby supporting a method for separately transmitting bearers between base stations. The MeNB and SeNB (Secondary eNB) are 5G base stations (Sub-6 GHz frequency) or 5G base stations (mmWave frequency), so the characteristics and capacities of the base stations may be different.

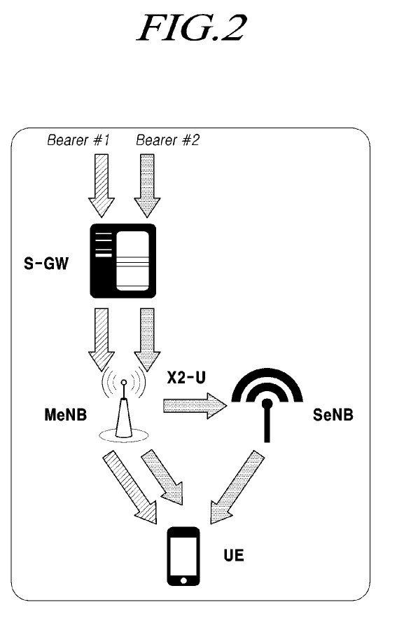

FIG. 2 shows a base station interoperation structure based on dual connectivity.

According to an embodiment, separate transmission of bearers may be dynamically performed between an MeNB and an SeNB, using slice IDs.

To this end, first, a RAN slicing orchestrator separately disposed inside or outside the PDCP of an MeNB maps a slice ID received from a core network terminal to a radio bearer. The number of Unack packets and the interface latency are calculated from the MeNB and SeNB. To this end, the MeNB and SeNB feed back necessary information p(PDCP SN), m(MeNB SN), s(SeNB SN), and d(interface latency) to the MeNB.

In particular, the value d is the latency in X2 interface and radio interface periods. The value d is calculated and transmitted for each of the MeNB and SeNB. The latency of a nonideal X2 interface may generally have a tolerance of 5-50 msec, depending on the characteristics and configuration of a transport network. Further, various types of CUs and AUs can be configured, and large-capacity transmission is required due to use of a mmWave wideband frequency, so latency due to fronthaul interface between two devices may be additionally considered.

1) When an SLID mapped to a radio bearer is SLID_{MBB}, the numbers of Unack packets at the MeNB and the SeNB are compared at a PDCP terminal. Then, when Nₛ(SeNB)≤Nₘ(MeNB) is satisfied, the SeNB is selected. Otherwise, the MeNB is selected for transmission.

That is, flow control is performed such that the throughput may be maximized, regardless of latency information by the interfaces.

When there is a large difference between supporting bandwidths of the MeNB and the SeNB, for example, when the MeNB supports a bandwidth of 20 MHz at a 3 GHz band and the SeNB supports a bandwidth 800 MHz at a 28 GHz band, all of bearer packets mapped to the SLID_{MBB} may be preferentially transmitted through the SeNB.

2) When a SLID mapped to a radio bearer is SLID_{MCMTC}, the interface latencies at the MeNB and the SeNB are compared at a PDCP terminal. When d(SeNB)<d(MeNB) and d(SeNB)<d_{SLID} are satisfied, the SeNB is preferentially selected. Otherwise, the MeNB is selected for transmission.

However, when d(MeNB)>d_{SLID} and d(SeNB)>d_{SLID} are both satisfied, the numbers of Unack packets at the MeNB and the SeNB are compared. When Nₛ(SeNB)≤Nₘ(MeNB) is satisfied as result of comparison, the SeNB is selected. Otherwise, the MeNB is selected for transmission.

That is, the interface latency information is preferentially considered for low-latency transmission, but when neither of the latencies of two base stations are satisfied, flow control is performed in consideration of the throughput.

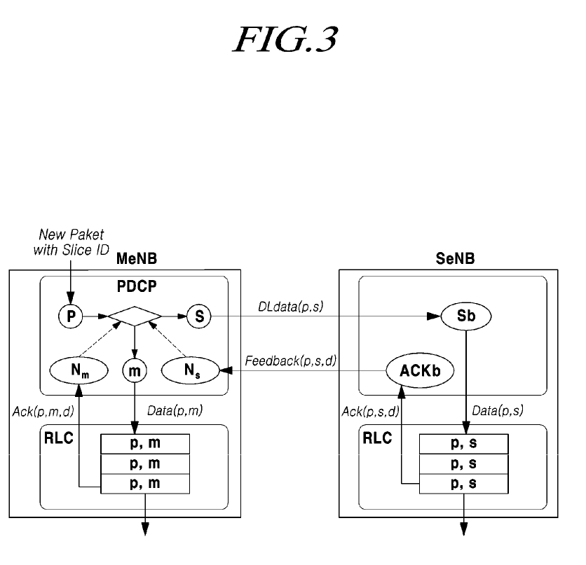

FIG. 3 shows packet flow control between base stations.

The factors described above may be defined as follows.

p: PDCP SN(Sequence Number), m: MeNB SN, s: SeNB SN

N: Number of Unack packets at corresponding base station (buffered or being transmitted at X2)

d: Latency at X2 or radio interface period

d_{SLID}: Maximum allowable latency of corresponding SLID

As described above, according to an embodiment, high-speed and low-latency wireless transmission of various 5G services may be stably performed by interoperated and separated transmission between base stations on a radio access network. Further, it is also possible to reduce the costs for construction/operation through efficient interoperations of a plurality of base stations.

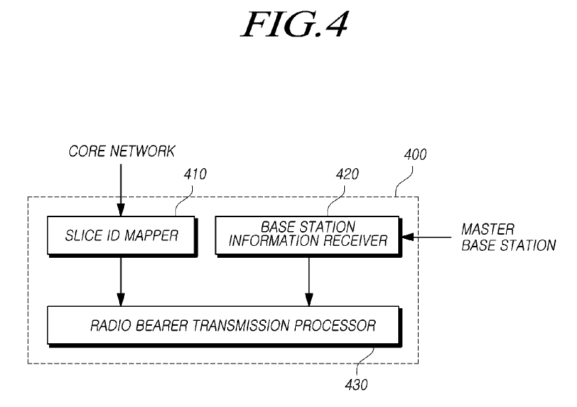

FIG. 4 is a diagram showing a radio access network slicing control device according to embodiments.

Referring to FIG. 4, the radio access network slicing control device 400 according to embodiments includes a slice ID mapper 410, a base station information receiver 420, and a radio bearer transmission processor 430.

The radio access network slicing control device 400 according to embodiments may be separately disposed inside or outside the PDCP of an MeNB.

The slice ID mapper 410 receives a slice ID from a core network and maps the received slice ID to a radio bearer.

The base station information receiver 420 receives necessary information on base stations to select a base station to transmit the radio bearer mapped with the slice ID.

For example, the base station information receiver 420 receives information about the number of Unack packets and interface latencies from an MeNB and an SeNB. The interface latencies may be values calculated respectively for the MeNB and the SeNB.

The MeNB and the SeNB may feedback p(PDCP SN), m(MeNB SN), s(SeNB SN), and d(interface latency) that are information, and the base station receiver 420 may receive the information from the MeNB.

The radio bearer transmission processor 430 selects a base station for transmitting the radio bearer, using the slice ID mapped to the radio bearer and the information received from the base station information receiver 420.

The radio bearer transmission processor 430 may select a base station for transmitting radio bearer mapped with the slice ID from the MeNB and the SeNB, using the type and characteristics of the service indicated by the slice ID and the information about the data of the MeNB and the SeNB.

For example, when the service indicated by the slice ID is a service required to quickly process large data, the radio bearer transmission processor 430 selects a base station for transmitting the radio bearer by comparing the number of Unack packets of the MeNB and the number of Unack packet of the SeNB with each other.

When the number of Unack packet of the SeNB is not larger than the number of Unack packets of the MeNB, the radio bearer transmission processor 430 transmits the radio bearer through the SeNB. When the number of Unack packet of the SeNB is larger than the number of Unack packets of the MeNB, the radio bearer transmission processor 430 transmits the radio bearer through the MeNB.

When the difference between the supporting bandwidths of the MeNB and the SeNB is a predetermined value or more, all radio bearer packets mapped with slice IDs may be transmitted through a base station having a larger bandwidth.

Alternatively, when the service indicated by the slice ID is a service requiring low latency and high reliability, the radio bearer transmission processor 430 compares the interface latencies of the MeNB and the SeNB with each other and selects a base station for transmitting the radio bearer.

The radio bearer transmission processor 430 may select a base station for transmitting the radio bearer, using the interface latency of the MeNB, the interface latency of the SeNB, and the maximum allowable latency of the slice ID.

When the interface latency of the SeNB is smaller than the interface latency of the MeNB and is smaller than the maximum allowable latency of the slice ID, the radio bearer transmission processor 430 transmits the radio bearer through the SeNB.

When this condition is not satisfied, the radio bearer is transmitted through the MeNB.

When the interface latency of the SeNB and the interface latency of the MeNB are both larger than the maximum allowable latency of the slice ID, the radio bearer transmission processor 430 may compare the number of Unack packets of the SeNB and the number of Unack packets of the MeNB with each other and select a base station for transmitting the radio bearer.

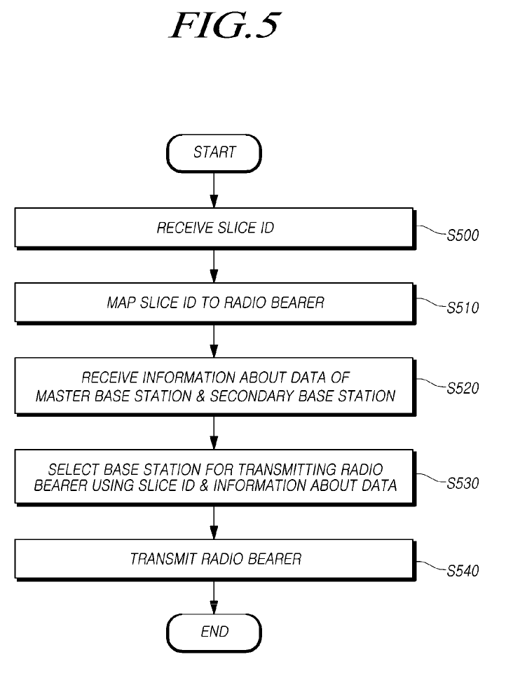

FIGS. 5 to 7 are flowcharts for showing a method of controlling radio bearer transmission through a radio access network slicing control device according to embodiments.

Referring to FIG. 5, the radio access network slicing control device 400 receives a slice ID from a core network (S500) and maps the received slice ID to a radio bearer (S510).

The device receives information on an MeNB and an SeNB through the MeNB (S520).

The radio access network slicing control device 400 selects a base station for transmitting the radio bearer, using the slice ID mapped to the radio bearer and the information received through the MeNB (S530) and transmits the radio bearer through the selected base station (S540).

When selecting a base station for transmitting the radio bearer, the radio access network slicing control device 400 may select a base station for transmitting the radio bearer, using the kind and characteristics of the service indicated by the slice ID mapped to the radio bearer and the information about the data of the MeNB and the SeNB.

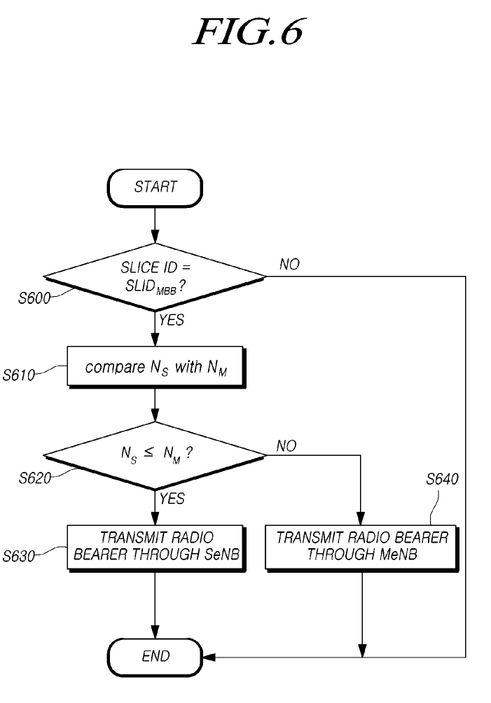

FIG. 6 is a flowchart for showing a method of controlling radio bearer transmission through a radio access network slicing control device according to embodiments when a slice ID is SLID_{MBB}.

Referring to FIG. 6, when a slice ID is SLID_{MBB} (S600), the radio access network slicing control device 400 compares N_{M} that is the number of Unack packets of an MeNB and N_{S} that is the number of Unack packets of an SeNB (S610).

When N_{S} is not larger than N_{M} (S620), the radio access network slicing control device 400 transmits a radio bearer through the SeNB (S630). When N_{S} is larger than N_{M}, the radio access network slicing control device 400 transmits a radio bearer through the MeNB (S640)

When the difference between the supporting bandwidths of the MeNB and the SeNB is large, it is possible to transmit a radio bearer through the base station having a larger supporting bandwidth of the MeNB and the SeNB.

That is, it is possible to control radio bearer transmission such that the throughput can be maximized, on the basis of the number of Unack packets or the supporting bandwidths of the MeNB and the SeNB regardless of latency information by interfaces.

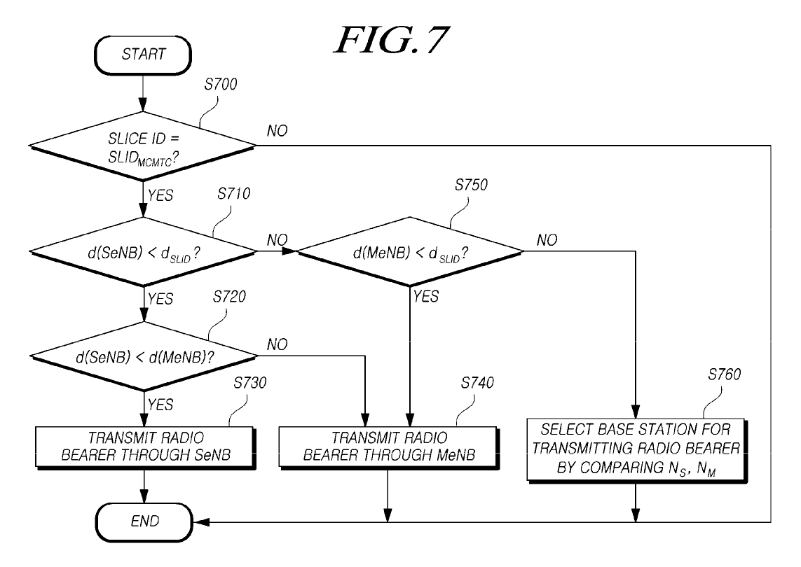

FIG. 7 is a flowchart for showing a method of controlling radio bearer transmission through a radio access network slicing control device according to embodiments when a slice ID is SLID_{MCMTC}.

Referring to FIG. 7, when a slice ID is SLID_{MCMTC} (S700), the radio access network slicing control device 400 compares the interface latency of an SeNB and the maximum allowable latency of the slice ID with each other (S710).

When the interface latency of the SeNB is smaller than the maximum allowable latency of the slice ID, the radio access network slicing control device 400 compares the interface latency of the SeNB and the interface latency of the MeNB with each other (S720).

When the interface latency of the SeNB is smaller even than the interface latency of the MeNB, the radio access network slicing control device 400 transmits the radio bearer through the SeNB (S730). When the interface latency of the SeNB is not smaller than the interface latency of the MeNB, the radio access network slicing control device 400 transmits the radio bearer through the MeNB (S740).

When the interface latency of an SeNB is not smaller than the maximum allowable latency of the slice ID, the radio access network slicing control device 400 compares the interface latency of an MeNB and the maximum allowable latency of the slice ID with each other (S750).

When the interface latency of the MeNB is smaller than the maximum allowable latency of the slice ID, the radio access network slicing control device 400 transmits the radio bearer through the MeNB (S740).

When the interface latency of the MeNB is not smaller than the maximum allowable latency of the slice ID, the radio access network slicing control device 400 compares the number of the Unack packets of the MeNB and the number of the Unack packets of the SeNB with each other and selects a base station for transmitting the radio bearer (S760).

That is, the radio access network slicing control device 400 select a base station for transmitting the radio bearer such that the latency can be minimized, and controls radio bearer transmission in consideration of the throughput when the interface latency of the MeNB and the SeNB are not smaller than the maximum allowable latency of the slice ID.

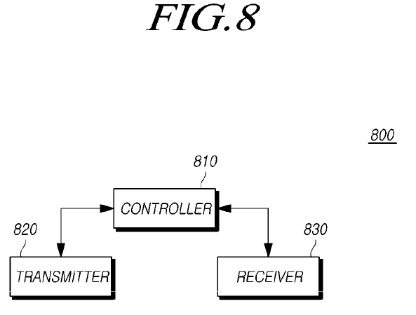

FIG. 8 is a diagram showing a base station according to an embodiment.

Referring to FIG. 8, a base station 800 according to an embodiment includes a controller 810, a transmitter 820, and a receiver 830.

The controller 810 controls the overall operation of the base station 800 that configures a radio bearer when different base stations cooperate with each other on a 5G RAN to which network slicing has been applied. Furthermore, the controller 810 may control operations of the base station 800 for stably performing high-speed and low-latency wireless transmission of various 5G services and for performing interoperated and separated transmission between base stations on a radio access network according to embodiments.

The transmitter 820 and the receiver 830 are used to transmit/receive signals or messages, and data to/from a terminal for performing interoperated and separated transmission between base stations on a radio access network according to embodiments.

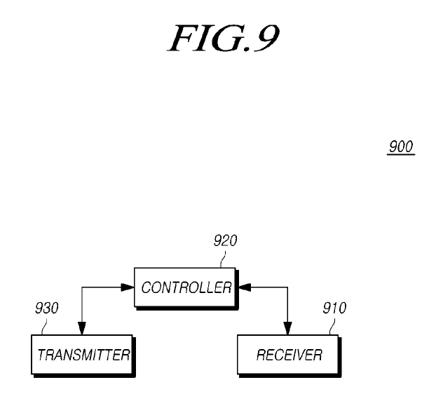

FIG. 9 is a diagram showing a user terminal according to an embodiment.

Referring to FIG. 9, a user terminal 900 according to another embodiment includes a receiver 910, a controller 920, and a transmitter 930.

The receiver 910 receives downlink control information, data, and messages from a base station through a corresponding channel.

The controller 920 controls the overall operation of the user terminal 900 that configures a radio bearer when different base stations cooperate with each other on a 5G RAN to which network slicing has been applied. The controller 920 may control the user terminal 900 for performing high-speed and low-latency wireless transmission of various 5G services and for stably performing interoperated and separated transmission between base stations on a radio access network according to embodiments.

The transmitter 930 transmits uplink control information, data, and messages to a base station through a corresponding channel.

The standard details or standard documents mentioned in the above embodiments are omitted for the simplicity of the description of the specification, and constitute a part of the present specification. Therefore, when a part of the contents of the standard details and the standard documents is added to the present specifications or is disclosed in the claims, it should be construed as falling within the scope of the present disclosure.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims. Therefore, exemplary aspects of the present disclosure have not been described for limiting purposes. The scope of the present disclosure shall be construed on the basis of the accompanying claims in such a manner that all of the technical ideas included within the scope equivalent to the claims belong to the present disclosure.

### CROSS-REFERENCE TO RELATED APPLICATION

If applicable, this application claims priority under 35 U.S.C § 119(a) of Patent Application No. 10-2016-0029431, filed on Mar. 11, 2016, and Patent Application No. 10-2017-0029374, filed on Mar. 8, 2017 in Korea, the entire contents of which are incorporated herein by reference. In addition, this non-provisional application claims priorities in countries other than the U.S. for the same reason based on the Korean Patent Applications, the entire contents of which are hereby incorporated by reference.

1. A method of controlling radio bearer transmission through a radio access network slicing control device, the method comprising:
receiving a slice ID from a core network;
mapping the received slice ID to a radio bearer; and
selecting a base station for transmitting the radio bearer based on the slice ID mapped to the radio bearer and information on a master base station and a secondary base station.

2. The method of claim 1, wherein the selecting of a base station for transmitting the radio bearer comprises:
when the slice ID mapped to the radio bearer indicates a service required to quickly process large data, comparing a number of packets that are not used of the master base station and a number of packets that are not used in the secondary base station; and
selecting a base station for transmitting the radio bearer based on the comparison result.

3. The method of claim 2, wherein when the number of packets that are not used in the secondary base station is not larger than the number of packets that are not used of the master base station, the radio bearer is transmitted through the second base station, and otherwise, the radio bearer is transmitted through the master base station.

4. The method of claim 2, wherein when a difference between a supporting bandwidth of the master base station and a supporting bandwidth of the secondary base station is equal to or greater than a predetermined value, the radio bearer is transmitted though the base station having a larger supporting bandwidth.

5. The method of claim 1, wherein the selecting of a base station for transmitting the radio bearer comprise:
when the slice ID mapped to the radio bearer indicates a service requiring low latency and high reliability, selecting a base station for transmitting the radio bearer based on latency of the master base station, latency of the secondary base station, and maximum allowable latency of the slice ID.

6. The method of claim 5, wherein when the latency of the secondary base station is smaller than the latency of the master base station and the maximum allowable latency of the slice ID, the radio bearer is transmitted through the secondary base station, and otherwise, the radio bearer is transmitted through the master base station.

7. The method of claim 6, wherein when the latency of the master base station is larger than the maximum allowable latency of the slice ID and when the latency of the secondary base station is larger than the maximum allowable latency of the slice ID, the number of packets that are not used of the master base station is compared with the number of packets that are not used of the secondary base station, and a base station for transmitting the radio bearer is selected based on the comparison result.

8. A radio access network slicing control device for controlling radio bearer transmission, the device comprising:
a slice ID mapper configured to receive a slice ID from a core network and map the received slice ID to a radio bearer;
a base station information receiver configured to receive information on a master base station and a secondary base station through the master base station; and
a radio bearer transmission processor configured to select a base station for transmitting the radio bearer based on the slice ID mapped to the radio bearer and the information on the master base station and the secondary base station.

9. The device of claim 8, wherein when the slice ID mapped to the radio bearer indicates a service required to quickly process large data, the radio bearer transmission processor compares the number of packets that are not used of the master base station and the number of packets that are not used in the secondary base station with each other and selects a base station for transmitting the radio bearer based on the comparison result.

10. The device of claim 9, wherein when the number of packets that are not used in the secondary base station is not larger than the number of packets that are not used of the master base station, the radio bearer transmission processor transmits the radio bearer through the second base station, and otherwise, the radio bearer transmission processor transmits the radio bearer through the master base station.

11. The device of claim 9, wherein when the difference between a supporting bandwidth of the master base station and a supporting bandwidth of the secondary base station is equal to or greater than a predetermined value, the radio bearer transmission processor transmits the radio bearer through the base station having a larger supporting bandwidth.

12. The device of claim 8, wherein when the slice ID mapped to the radio bearer indicates a service requiring low latency and high reliability, the radio bearer transmission processor selects a base station for transmitting the radio bearer based on latency of the master base station, latency of the secondary base station, and maximum allowable latency of the slice ID.

13. The device of claim 12, wherein when the latency of the secondary base station is smaller than the latency of the master base station and the maximum allowable latency of the slice ID, the radio bearer transmission processor transmits the radio bearer through the secondary base station, and otherwise, radio bearer transmission processor transmits the radio bearer through the master base station.

14. The device of claim 13, wherein when the latency of the master base station is larger than the maximum allowable latency of the slice ID and when the latency of the secondary baste station is larger than the maximum allowable latency of the slice ID, the radio bearer transmission processor compares the number of packets that are not used of the master base station and the number of packets that are not used of the secondary base station with each other and selects a base station for transmitting the radio bearer based on the comparison result.

15. The method of claim 1,
wherein the slice ID is information for discriminating and identifying a slice for each service.

16. The method of claim 15,
wherein the slice includes the base station part and the core network part.

17. The method of claim 15,
wherein the slice includes different network functions and service levels according to different service requirements.
